(19) United States
(12) Patent Application Publication
(10) Pub. No.: US 2007/0136500 A1
(43) Pub. Date: Jun. 14, 2007

(54) Controlling system using inter integrated circuit bus having single clock line

(75) Inventor: Yi-Hsiang Kao, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/638,633

(22) Filed: Dec. 12, 2006

(30) Foreign Application Priority Data
Dec. 12, 2005 (CN) 200510101270.7

(51) Int. Cl. G06F 13/00

(52) U.S. Cl. 710/100

(57) ABSTRACT

An exemplary inter integrated circuit bus of a controlling system (200) includes a clock line (SCL11), data lines (SDA12, SDA13, SDA14), a programmed control unit (20), and peripheral devices each having an address. The programmed control unit includes a plurality of ports (11˜14) which are connected to the clock line and the data lines respectively. The programmed control unit controls each peripheral device by transmitting a clock signal and a controlling signal thereto via the clock line and one of the data lines that has the same address as that of the peripheral device.

### FIELD OF THE INVENTION

The present invention relates to controlling systems in electronic devices such as computers, and more particularly to a controlling system using an inter integrated circuit bus for transmitting controlling signals.

### BACKGROUND

An inter integrated circuit bus is a two-wire universal serial bus (USB) which is generally used in an integrated circuit such as a chip for transmitting signals. The chip may be part of any of multifarious electronic devices such as, for example, a liquid crystal display (LCD). The inter integrated circuit bus is a control bus formed by bidirectional data transmission lines. These two lines are divided into a serial data line (SDA) and a serial clock line (SCL). A plurality of peripheral devices can be connected to the USB, each peripheral device being designated with a unique address for the purpose of data transmission. The inter integrated circuit bus allows peripheral devices which are compatible with each other to share a same bus for data transmission. The peripheral devices may, for example, be a memory, a digital-to-analog converter, and a liquid crystal display driver of a liquid crystal display. Data transmitted for each of the peripheral devices connected to the inter integrated circuit bus is transmitted according to the unique address of the peripheral device. Therefore, address selection by an extra internal logical circuit is not required.

In general, the inter integrated circuit bus is controlled by a single host device at any one time, and each guest (peripheral) device transmits a data signal while the inter integrated circuit bus is idle. In some cases, one or more peripheral devices can act as either a host device or a guest device. In such cases, the inter integrated circuit bus can arbitrate which of the possible host devices controls the inter integrated circuit bus, thereby controlling other eligible peripheral devices as guest devices. The inter integrated circuit bus also performs the function of bus arbitrating, and high-low speed synchronizing for devices that have multiple hosts.

Referring to FIG. 2, this shows an inter integrated circuit bus of an exemplary conventional controlling system 100. The controlling system 100 includes a microprogrammed control unit 10, a first clock line SCL1, a first data line SDA1, a second clock line SCL2, a second data line SDA2, a third clock line SCL3, and a third data line SDA3. The microprogrammed control unit 10 includes a first port 1, a second port 2, a third port 3, a fourth port 4, a fifth port 5, and a sixth port 6. The first port 1 is connected to the first clock line SCL1, the second port 2 is connected to the first data line SDA1, the third port 3 is connected to the second clock line SCL2, the fourth port 4 is connected to the second data line SDA2, the fifth port 5 is connected to the third clock line SCL3, and the sixth port 6 is connected to the third data line SDA3. A first clock signal and a first controlling signal are transmitted from the first and second ports 1, 2 by the first clock line SCL1 and the first data line SDA1 respectively to a first peripheral device (not shown). A second clock signal and a second controlling signal are transmitted from the third and fourth ports 3, 4 by the second clock line SCL2 and the second data line SDA2 respectively to a second peripheral device (not shown). A third clock signal and a third controlling signal are transmitted from the fifth and sixth ports 5, 6 respectively to a third peripheral device (not shown). The first, second and the third peripheral devices have a same address.

If the number of peripheral devices is N (N is a natural number), the microprogrammed control unit 10 requires 2N ports for transmitting controlling signals to the peripheral devices. The number of needed ports increases along with the number of peripheral devices. Therefore conventional controlling systems such as the controlling system 100 are liable to have complicated structures and be costly.

Accordingly, what is needed is an inter integrated circuit of a-controlling system configured to overcome the above-described problems.

### SUMMARY

An exemplary inter integrated circuit bus of a controlling system includes a clock line, a plurality of data lines, at least one programmed control unit, and at least one peripheral device each having an address. The at least one programmed control unit includes a plurality of ports which are connected to the clock line and the data lines respectively. The programmed control unit controls each peripheral device by transmitting a clock signal and a controlling signal thereto via the clock line and one of the data lines that has the same address as that of the at least one peripheral device.

A detailed description of embodiments of the present invention is given below with reference to the accompanying drawings.

### BRIEF DESCRIPTION OF THE DRAWINGS

FIG. 1 is an equivalent circuit diagram of a controlling system having an inter integrated circuit bus in accordance with an exemplary embodiment of the present invention.

FIG. 2 is an equivalent circuit diagram of a conventional controlling system having an inter integrated circuit bus.

### DETAILED DESCRIPTION OF PREFERRED EMBODIMENTS

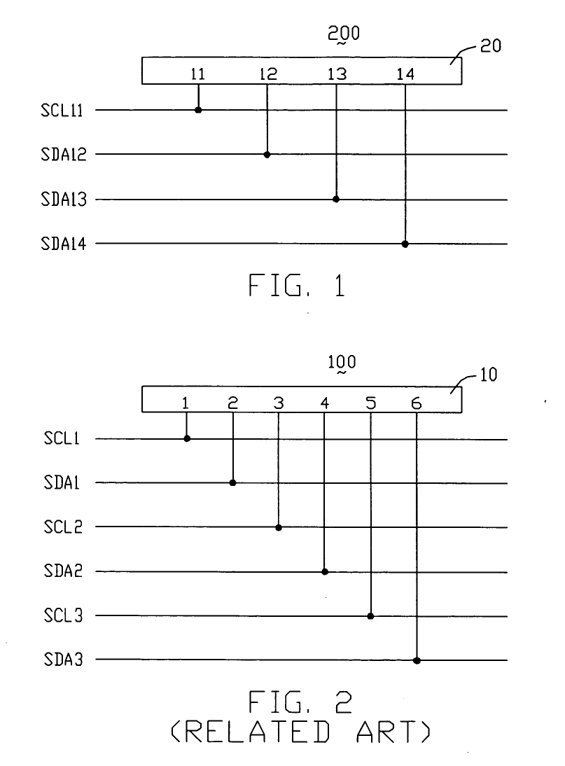

Referring to FIG. 1, this is an equivalent circuit diagram of a controlling system having an inter integrated circuit bus in accordance with an exemplary embodiment of the present invention. The controlling system 200 includes at least one programmed control unit, a clock line SCL11, a first data line SDA12, a second data line SDA13, and a third data line SDA14. In the illustrated embodiment, the at least one programmed control unit is a single microprogrammed control unit 20. The microprogrammed control unit 20 includes a first port 11, a second port 12, a third port 13, and a fourth port 14. The first, second, third, and fourth ports 11, 12, 13, 14 are connected to the clock line SCL11, the first data line SDA12, the second data line SDA13, and the third data line SDA14 respectively. A first clock signal and a first controlling signal are transmitted from the first and second ports 11, 12 by the clock line SCL11 and the first data line SDA12 respectively to a first peripheral device (not shown). A second clock signal and a second controlling signal are transmitted from the first and third ports 11, 13 by the clock line SCL11 and the second data line SDA13 respectively to a second peripheral device (not shown). A third clock signal and a third controlling signal are transmitted from the first and fourth ports 11, 14 by the clock line SCL11 and the third data line SDA14 respectively to the third peripheral device (not shown). The first, second and third peripheral devices have a same address.

If the number of peripheral devices is N (N is a natural number), the microprogrammed control unit 20 requires N+1 ports for transmitting the controlling signals to the peripheral devices.

In other examples, the microprogrammed control unit 20 can be replaced by an application specific integrated circuit (ASIC); for example, the driving circuit of a liquid crystal display, a memory, or a complex instruction set computer (CISC). Further, a plurality of microprogrammed control units 20 can be adopted for controlling the peripheral devices, with each of the microprogrammed control units 20 being connected to the clock line SCL11, the first data line SDA12, the second data line SDA13, and the third data line SDA14 respectively.

While preferred and exemplary embodiments have been described above, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A controlling system with an inter integrated circuit bus, comprising;
a clock line;
a plurality of data lines;
at least one programmed control unit comprising a plurality of ports connected to the clock line and the data lines respectively; and
at least one peripheral device having an address;
wherein the programmed control unit controls the at least one peripheral device by transmitting a clock signal thereto via the clock line and a controlling signal thereto via one of the data lines that has the same address as that of the at least one peripheral device.

2. The controlling system as claimed in claim 1, wherein the at least one programmed control unit is a microprogrammed control unit.

3. The controlling system as claimed in claim 1, wherein the at least one programmed control unit is an application specific integrated circuit.

4. The controlling system as claimed in claim 1, wherein the at least one programmed control unit is a complex instruction set computer.

5. A controlling system with an inter integrated circuit bus, comprising;
a clock line;
a plurality of data lines;
at least one programmed control unit comprising a plurality of ports connected to the clock line and the data lines respectively; and
a plurality of peripheral devices, each of the peripheral devices having an address;
wherein the at least one programmed control unit controls each of the peripheral devices by transmitting a clock signal thereto via the clock line and a controlling signal thereto via one of the data lines that has the same address as that of the peripheral device.

6. The controlling system as claimed in claim 5, wherein the at least one programmed control unit is a microprogrammed control unit.

7. The controlling system as claimed in claim 5, wherein the at least one programmed control unit is an application specific integrated circuit.

8. The controlling system as claimed in claim 5, wherein the at least one programmed control unit is a complex instruction set computer.
